(19) United States
(12) Patent Application Publication
(10) Pub. No.: US 2026/0043756 A1
(43) Pub. Date: Feb. 12, 2026

(54) X-Ray Image Preprocessing Method, X-Ray Image Preprocessing Program, and X-Ray Image Preprocessing System

(71) Applicant: SHIMADZU CORPORATION, Kyoto-shi (JP)

(72) Inventor: Hiroaki TSUSHIMA, Kyoto-shi (JP)

(21) Appl. No.: 19/296,440

(22) Filed: Aug. 11, 2025

(30) Foreign Application Priority Data
Aug. 9, 2024 (JP) 2024-134655

(51) Int. Cl. G01N 23/04; G06T 5/94; G06T 7/00

(52) U.S. Cl. CPC G01N 23/04; G06T 5/94; G06T 7/0004; G01N 2223/401; G06T 2207/10116; G06T 2207/20081; G06T 2207/30141; G06T 2207/30152

(57) ABSTRACT

An X-ray image preprocessing method is performed prior to a process of acquiring a region of an inspection object 90 from an X-ray image 40 using a trained model 31. The method comprises a step of acquiring the X-ray image 40, a step of acquiring a plurality of regions from the X-ray image 40, a step of acquiring an X-ray image representative value 50 of pixel values of each of the plurality of regions, and a step of acquiring a contrast-adjusted X-ray image 44 by performing contrast adjustment on the X-ray image 40 such that each X-ray image representative value 50 becomes a predetermined value 70 acquired based on input training data 32 used when creating the trained model 31.

### TECHNICAL FIELD

The present invention relates to an X-ray image preprocessing method, an X-ray image preprocessing program, and an X-ray image preprocessing system, and more particularly to an X-ray image preprocessing method, an X-ray image preprocessing program, and an X-ray image preprocessing system for analyzing an X-ray image using a trained model.

### BACKGROUND ART

Conventionally, an apparatus that analyzes an X-ray image using a trained model is known (see, for example, Patent Literature 1).

Patent Literature 1 discloses an X-ray imaging system that identifies at least one of a region of an inspection object and a region of an abnormal part included in the inspection object, using a trained model. The X-ray imaging system disclosed in Patent Literature 1 includes a fluoroscopic apparatus and an analysis apparatus. In the configuration disclosed in Patent Literature 1, an X-ray image generated by imaging an inspection object with the fluoroscopic apparatus is analyzed by the analysis apparatus. Specifically, in the configuration disclosed in Patent Literature 1, the analysis apparatus is configured to identify the region of the inspection object by inputting the X-ray image into the trained model.

### CITATION LIST

### Patent Literature

[Patent Literature 1] Japanese Unexamined Patent Application Publication No. 2024-029975

### SUMMARY OF INVENTION

### Technical Problem

Although not described in Patent Literature 1, when performing a process to identify (acquire) the region of an inspection object from an X-ray image of the inspection object using a trained model, a user captures an X-ray image by setting the imaging conditions, including at least one of tube voltage and tube current, to be identical when capturing the training data (training X-ray image) for generating the trained model and when capturing the X-ray image for analysis using the trained model. However, due to the aging degradation of the X-ray imaging apparatus, even when the user sets the tube voltage and tube current to irradiate X-rays with a predetermined energy and dose, X-ray energy and dose actually irradiated from the X-ray irradiation unit may become lower than the energy and dose intended by the user. In this case, since the imaging conditions at the time the trained model was created and the imaging conditions at the time the X-ray image was captured are different from each other, the analysis accuracy in the process (analysis) of acquiring the region of the inspection object using the trained model decreases. Furthermore, if the X-ray irradiation unit is replaced after capturing the training data used to generate the trained model, even if the tube voltage and tube current values are set to the same values as when the training data was captured, X-ray energy and dose actually irradiated from the X-ray irradiation unit when capturing the X-ray image may become higher than X-ray energy and dose when the training data was captured. In this case as well, since the imaging conditions at the time the trained model was created and the imaging conditions at the time the X-ray image was captured are different from each other, the analysis accuracy in the process (analysis) of acquiring the region of the inspection object using the trained model decreases. Moreover, a discrepancy arises between the imaging conditions set by the user and the actual imaging conditions due to the aging degradation of the X-ray imaging apparatus. Therefore, even if a plurality of trained models are generated based on training data captured under a plurality of imaging conditions, it is difficult to select a trained model that was generated based on training data with imaging conditions that match the actual imaging conditions. For this reason, there is a demand for a technology capable of suppressing a decrease in the accuracy of the process for acquiring the region of the inspection object, even when the imaging conditions for capturing the training data used to generate the trained model and the imaging conditions for capturing the X-ray image to be analyzed by the trained model are different from each other.

The present invention has been made to solve the above-described problems, and an object of the present invention is to provide an X-ray image preprocessing method, an X-ray image preprocessing program, and an X-ray image preprocessing system capable of suppressing a decrease in the accuracy of the process for acquiring (identifying) a region of an inspection object using a trained model, even when the imaging conditions for capturing the training data used to generate the trained model and the imaging conditions for capturing the X-ray image to be analyzed by the trained model are different from each other.

### Solution to Problem

To achieve the above object, an X-ray image preprocessing method according to a first aspect of the present invention is an X-ray image preprocessing method performed prior to a process of acquiring a region of an inspection object from an X-ray image of the inspection object using a trained model, the method comprising: a step of acquiring the X-ray image; a step of acquiring a plurality of regions from the X-ray image based on pixel values of the X-ray image; a step of acquiring an X-ray image representative value of the pixel values of each of the plurality of regions; and a step of acquiring a contrast-adjusted X-ray image by performing contrast adjustment on the X-ray image such that each of the X-ray image representative values of the plurality of regions of the X-ray image becomes a predetermined value acquired based on training data used when creating the trained model.

An X-ray image preprocessing program according to a second aspect of the present invention is an X-ray image preprocessing program performed prior to a process of acquiring a region of an inspection object from an X-ray image of the inspection object using a trained model, the program causing a computer to execute: a control to acquire the X-ray image; a control to acquire a plurality of regions from the X-ray image based on pixel values of the X-ray image; a control to acquire an X-ray image representative value of the pixel values of each of the plurality of regions; and a control to acquire a contrast-adjusted X-ray image by performing contrast adjustment on the X-ray image such that each of the X-ray image representative values of the plurality of regions of the X-ray image becomes a predetermined value acquired based on training data used when creating the trained model.

An X-ray image preprocessing system according to a third aspect of the present invention is an X-ray image preprocessing system performed prior to a process of acquiring a region of an inspection object from an X-ray image of the inspection object using a trained model, the system comprising: an X-ray imaging apparatus having an X-ray irradiation unit that irradiates X-rays and an X-ray detector that detects the X-rays irradiated from the X-ray irradiation unit; and an image processing apparatus that generates an X-ray image, wherein the image processing apparatus performs: a control to generate the X-ray image; and a control to acquire a plurality of regions from the X-ray image based on pixel values of the X-ray image, acquire an X-ray image representative value of the pixel values of each of the plurality of regions, and acquire a contrast-adjusted X-ray image by performing contrast adjustment on the X-ray image such that each of the X-ray image representative values of the plurality of regions of the X-ray image becomes a predetermined value acquired based on training data used when creating the trained model.

### Advantageous Effects of Invention

When an X-ray imaging apparatus undergoes aging degradation, even if a user sets the tube voltage and tube current to irradiate X-rays with a predetermined energy and dose, at least one of X-ray energy and dose actually irradiated from the X-ray irradiation unit may become lower. Therefore, when the X-ray imaging apparatus undergoes aging degradation, the X-ray image is captured under imaging conditions where at least one of the X-ray energy and dose is lower than the imaging conditions set by the user, resulting in a decrease in contrast between the plurality of regions in the X-ray image. Furthermore, if the X-ray irradiation unit is replaced after capturing the training data used to generate the trained model, even if the user sets values equal to the tube voltage and tube current values that were set when capturing the training data, at least one of X-ray energy and dose actually irradiated from the X-ray irradiation unit may become higher than at least one of X-ray energy and dose irradiated from the X-ray irradiation unit when the training data was captured. In this case, since the X-ray image is captured under imaging conditions where at least one of the X-ray energy and dose is higher than the imaging conditions when the training data was captured, the contrast between the plurality of regions in the X-ray image becomes greater than the contrast between the plurality of regions in the training data.

Therefore, in the X-ray image preprocessing method according to the first aspect, the X-ray image preprocessing program according to the second aspect, and the X-ray image preprocessing system according to the third aspect, a contrast-adjusted X-ray image is acquired by performing contrast adjustment on the X-ray image such that each X-ray representative value of the plurality of regions of the X-ray image becomes a predetermined value acquired based on the training data used when creating the trained model. As a result, in both the case where at least one of X-ray energy and dose irradiated from the X-ray irradiation unit becomes lower and the contrast between the plurality of regions in the X-ray image becomes lower than the contrast between the plurality of regions in the training data, and the case where the contrast between the plurality of regions in the X-ray image becomes greater than the contrast between the plurality of regions in the training data, it is possible to acquire a contrast-adjusted X-ray image in which the contrast is adjusted so that the representative value of each of the plurality of regions becomes the predetermined value. Accordingly, the contrast between the plurality of regions in the X-ray image can be brought closer to the contrast between the plurality of regions in the training data. Consequently, even when the imaging conditions for capturing the training data for generating the trained model and the imaging conditions for capturing the X-ray image to be analyzed by the trained model are different from each other, it is possible to suppress a decrease in the accuracy of the process for acquiring (identifying) the region of the inspection object using the trained model. It should be noted that the ability to suppress a decrease in the accuracy of the process for acquiring the region of the inspection object has been confirmed in an experiment described later by the present inventors.

### BRIEF DESCRIPTION OF DRAWINGS

FIG. 1 is a block diagram showing the overall configuration of an X-ray imaging system according to an embodiment of the present invention.

FIG. 2 is a diagram showing an example of an inspection object.

FIG. 3 is a block diagram for explaining the functional configuration of a control unit.

FIG. 4 is a diagram showing an example of an X-ray image.

FIG. 5 is a diagram for explaining a configuration for generating a trained model and a configuration for analyzing an X-ray image using the trained model.

FIG. 6 is a diagram for explaining a configuration in which the control unit performs logarithmic transformation processing.

FIG. 7 is a diagram for explaining a configuration in which the control unit acquires a solder ball region and a background region.

FIG. 8 is a diagram for explaining a configuration in which the control unit acquires a first average pixel value and a second average pixel value.

FIG. 9 is a diagram for explaining a configuration in which the control unit acquires a contrast-adjusted X-ray image.

FIG. 10 is a flowchart for explaining a process in which the control unit acquires a contrast-adjusted X-ray image.

FIG. 11 is a diagram for explaining the result of analyzing an X-ray image according to a first comparative example with a trained model.

FIG. 12 is a diagram for explaining the result of analyzing a contrast-adjusted X-ray image according to a first example with a trained model.

FIG. 13 is a diagram for explaining the result of analyzing an X-ray image according to a second comparative example with a trained model.

FIG. 14 is a diagram for explaining the result of analyzing a contrast-adjusted X-ray image according to a second example with a trained model.

### DESCRIPTION OF EMBODIMENTS

Hereinafter, embodiments embodying the present invention will be described based on the drawings.

### (Overall Configuration of X-ray Imaging System)

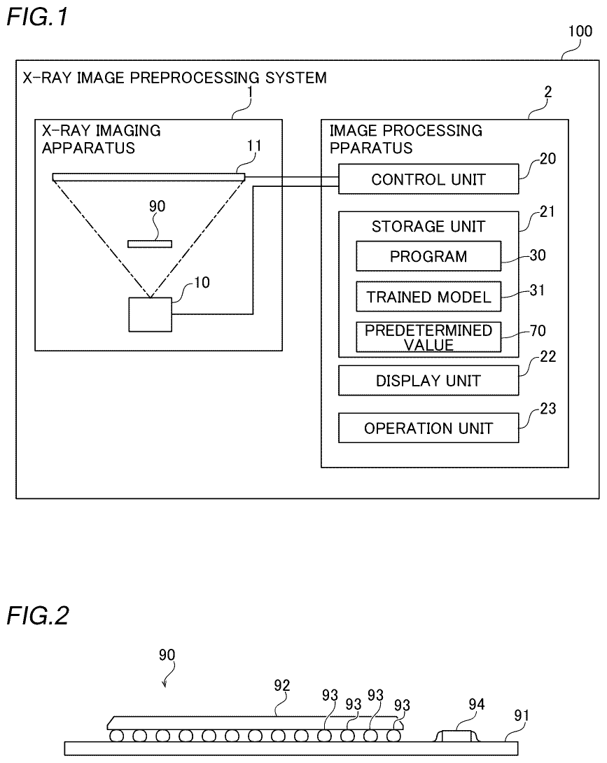

An X-ray image preprocessing system 100 according to an embodiment of the present invention will be described with reference to FIG. 1 to FIG. 10.

As shown in FIG. 1, the X-ray image preprocessing system 100 of the present embodiment is a system that images the interior of an inspection object 90 by detecting X-rays that have passed through the inspection object 90. The X-ray image preprocessing system 100 is used, for example, for imaging the interior of an inspection object 90, which is an object, for non-destructive inspection purposes.

As shown in FIG. 2, the inspection object 90 is an electronic device including a circuit board (or a printed board) 91. An electronic component 92 is mounted on the circuit board 91. The electronic component 92 is electrically connected to the circuit board 91 by a plurality of solder balls 93 (bumps). The plurality of solder balls 93 are arranged in a regular pattern. Specifically, the plurality of solder balls 93 are arranged in a grid pattern on the circuit board 91 so as to have regularity. That is, the electronic component 92 is connected to the circuit board 91 by a BGA (Ball Grid Array). A plurality of solder balls 93 are arranged on one surface of the circuit board 91. The electronic component 92 includes, for example, an electronic circuit such as an IC (integrated circuit). In the X-ray image preprocessing system 100, preprocessing is performed on an X-ray image 40 (see FIG. 4) used for non-destructive inspection for abnormalities such as voids and bridges in the plurality of solder balls 93. In addition to the electronic component 92, electronic components 94 such as surface-mounted resistors or capacitors are also mounted on the circuit board 91.

As shown in FIG. 1, the X-ray image preprocessing system 100 includes an X-ray imaging apparatus 1 and an image processing apparatus 2. The X-ray imaging apparatus 1 performs X-ray imaging on the inspection object 90. The image processing apparatus 2 generates an X-ray image 40 (see FIG. 4). The image processing apparatus 2 also performs an analysis process using a trained model 31 and a preprocessing for the analysis process on the generated X-ray image 40. That is, the X-ray image preprocessing system 100 is an X-ray image preprocessing system that operates prior to the process of acquiring a region of the inspection object 90 from the X-ray image 40 of the inspection object 90 using the trained model 31. The X-ray imaging apparatus 1 and the image processing apparatus 2 each have a communication module and exchange information with each other via a network or the like.

The X-ray imaging apparatus 1 has an X-ray irradiation unit 10 and an X-ray detector 11. The X-ray irradiation unit 10 is configured to irradiate X-rays. In the present embodiment, the X-ray irradiation unit 10 irradiates X-rays onto the inspection object 90 including the plurality of solder balls 93. The X-ray irradiation unit 10 includes an X-ray tube that irradiates X-rays by receiving power from a power supply device (not shown).

The X-ray detector 11 detects the X-rays irradiated from the X-ray irradiation unit 10. The X-ray detector 11 outputs an electrical signal corresponding to the detected X-rays. The X-ray detector 11 includes, for example, an FPD (Flat Panel Detector), which is an X-ray detector. The X-ray irradiation unit 10 and the X-ray detector 11 are disposed inside a housing (not shown) of the X-ray imaging apparatus 1.

As shown in FIG. 1, the image processing apparatus 2 has a control unit 20 and a storage unit 21. The image processing apparatus 2 is, for example, a personal computer communicably connected to the X-ray imaging apparatus 1. The control unit 20 controls the operation of each part of the X-ray imaging apparatus 1. The control unit 20, for example, controls the irradiation of X-rays by the X-ray irradiation unit 10 by controlling a power supply device (not shown). The control unit 20 includes a CPU (Central Processing Unit), ROM (Read Only Memory), RAM (Random Access Memory), and the like. The control unit 20 may also include a processor such as a GPU (Graphics Processing Unit) or an FPGA (Field-Programmable Gate Array) configured for image processing.

The storage unit 21 is configured to store various programs 30 to be executed by the control unit 20, and parameters. The storage unit 21 is also configured to store a trained model 31 and a predetermined value 70. Details of the trained model 31 and the predetermined value 70 will be described later. The storage unit 21 includes, for example, a non-volatile memory such as an HDD (Hard Disk Drive) or an SSD (Solid State Drive). The program 30 is an example of the “X-ray image preprocessing program” in the claims.

A display unit 22 and an operation unit 23 are connected to the image processing apparatus 2. The display unit 22 includes, for example, a liquid crystal monitor. The display unit 22 displays images and character information under the control of the control unit 20. The operation unit 23 accepts input operations from an operator. The operation unit 23 includes, for example, a keyboard and a pointing device such as a mouse. The operation unit 23 outputs an operation signal based on the accepted input operation to the control unit 20.

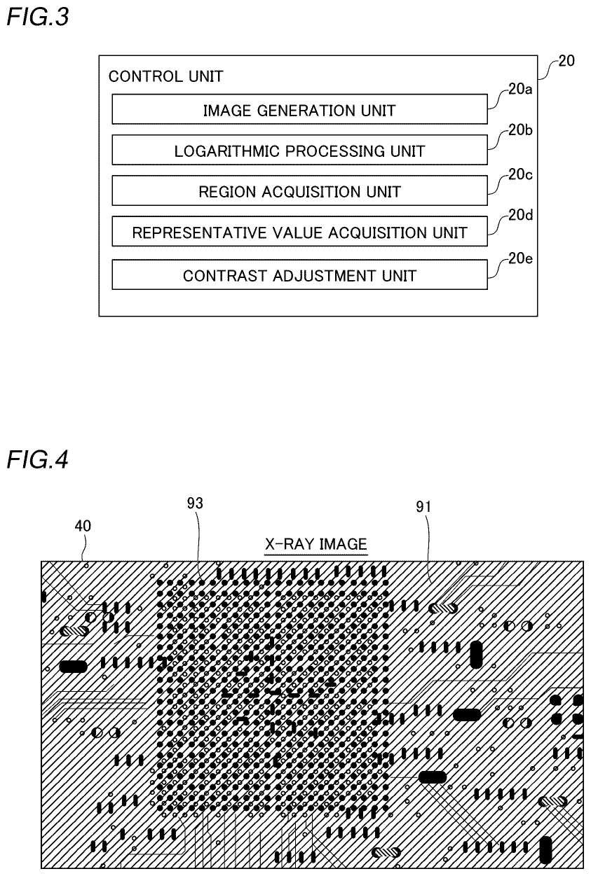

As shown in FIG. 3, the control unit 20 includes an image generation unit 20a, a logarithmic processing unit 20b, a region acquisition unit 20c, a representative value acquisition unit 20d, and a contrast adjustment unit 20e as functional blocks. The image generation unit 20a, the logarithmic processing unit 20b, the region acquisition unit 20c, the representative value acquisition unit 20d, and the contrast adjustment unit 20e are configured as software functional blocks realized by the control unit 20 executing a program 30 (see FIG. 2) stored in the storage unit 21 (see FIG. 2). In other words, the program 30 is configured to cause a computer (the control unit 20) to execute the respective controls performed by the image generation unit 20a, the logarithmic processing unit 20b, the region acquisition unit 20c, the representative value acquisition unit 20d, and the contrast adjustment unit 20e.

The image generation unit 20a, the logarithmic processing unit 20b, the region acquisition unit 20c, the representative value acquisition unit 20d, and the contrast adjustment unit 20e may be configured with dedicated processors (processing circuits) and constituted by separate hardware from each other.

The image generation unit 20a generates an X-ray image 40 (see FIG. 4) based on the X-rays detected by the X-ray detector 11 (see FIG. 1).

Details of the functions of the logarithmic processing unit 20b, the region acquisition unit 20c, the representative value acquisition unit 20d, and the contrast adjustment unit 20e will be described later.

### (X-Ray Image)

As shown in FIG. 4, the X-ray image 40 shows the plurality of solder balls 93 arranged in a regular grid pattern on the circuit board 91.

### (Trained Model)

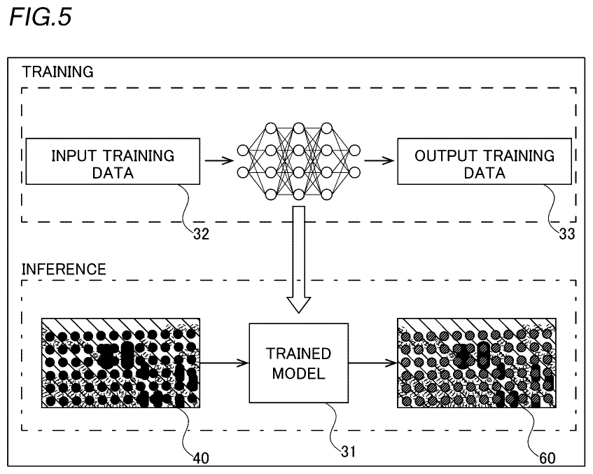

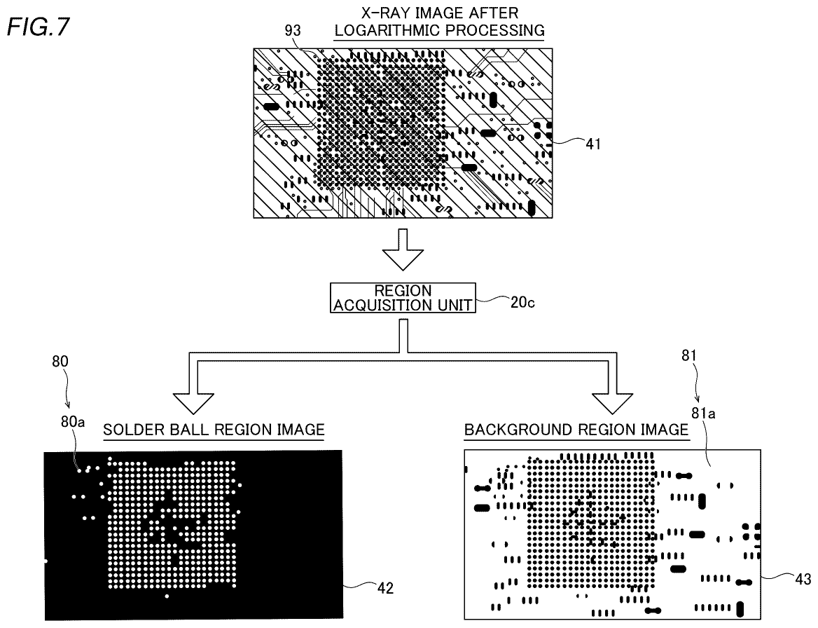

As shown in FIG. 5, the trained model 31 is used for the analysis of the X-ray image 40. Specifically, the trained model 31 is used to identify a solder ball region 80a (see FIG. 7), which is a region of the solder balls 93 (see FIG. 4). The trained model 31 is generated by the image processing apparatus 2 (see FIG. 1) or a computer different from the image processing apparatus 2 and is stored in advance in the storage unit 21 (see FIG. 1).

As shown in FIG. 5, the trained model 31 is generated by machine learning using a dataset of input training data 32 and output training data 33. The input training data 32 is generated based on a training X-ray image (not shown). The training X-ray image is generated by the X-ray imaging apparatus 1, similar to the X-ray image 40 (see FIG. 4) to be analyzed. The X-ray image 40 to be analyzed and the training X-ray image for generating the trained model 31 are images that include an inspection object 90 (solder balls 93) having a common structure. The input training data 32 is an example of the “training data” in the claims.

The output training data 33 is generated based on the training X-ray image. The output training data 33 is generated by a user applying a label to the region where the solder balls 93 appear in the training X-ray image.

The trained model 31 is generated by machine learning using deep learning. The deep learning includes, for example, machine learning based on U-Net, which is a type of Fully Convolutional Network (FCN). The trained model 31 is generated by training it to perform image transformation (image reconstruction) that can identify a region of the solder balls 93 (solder ball region 80a) and a background region 80b other than the solder balls 93 for each pixel in each of the input X-ray images 40.

As shown in FIG. 5, when an X-ray image 40 is input, the trained model 31 is configured to output an identification result image 60. The identification result image 60 is a label image in which the region of the solder balls 93 and the other regions in the X-ray image 40 are identified.

When analyzing the X-ray image 40 using the trained model 31, the imaging conditions (tube voltage and tube current) at the time of capturing the input training data 32 for generating the trained model 31 and the imaging conditions at the time of capturing the X-ray image 40 are matched. However, as the usage period of the X-ray imaging apparatus 1 (see FIG. 1) elapses, the X-ray irradiation unit 10 (see FIG. 1) undergoes aging degradation. When the X-ray irradiation unit 10 undergoes aging degradation, even if the user sets the tube voltage and tube current to irradiate X-rays with a predetermined energy and dose, X-rays with a lower energy and dose than intended are irradiated from the X-ray irradiation unit 10. Furthermore, if the X-ray irradiation unit 10 is replaced after capturing the input training data 32, even if the user sets values equal to the tube voltage and tube current values that were set when capturing the input training data 32, X-ray energy and dose actually irradiated from the X-ray irradiation unit 10 may become higher than X-ray energy and dose irradiated from the X-ray irradiation unit 10 when capturing the input training data 32. That is, even if the tube voltage and tube current set by the user are the same, a discrepancy may occur between the imaging conditions for the training data when generating the trained model 31 and the actual imaging conditions when capturing the X-ray image 40. If a discrepancy occurs between the actual imaging conditions when capturing the X-ray image 40 and the imaging conditions for the training data when generating the trained model 31, the properties of the obtained image change non-linearly. Therefore, if a discrepancy occurs between the imaging conditions at the time of capturing the training data and the imaging conditions at the time of capturing the X-ray image 40, the analysis accuracy by the trained model 31 decreases.

### (Acquisition of Contrast-Adjusted X-ray Image)

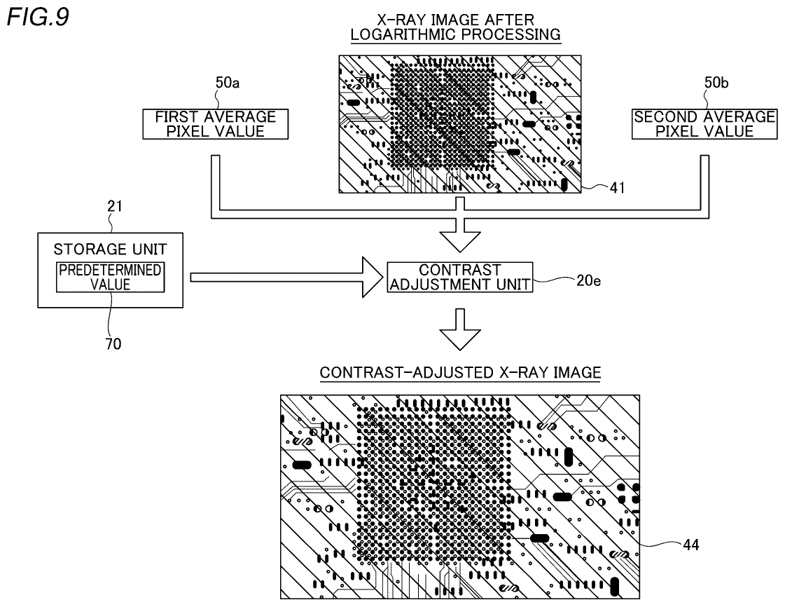

Therefore, in the present embodiment, a contrast-adjusted X-ray image 44 (see FIG. 9) is acquired by performing preprocessing on the X-ray image 40. Then, the acquired contrast-adjusted X-ray image 44 is used for analysis using the trained model 31.

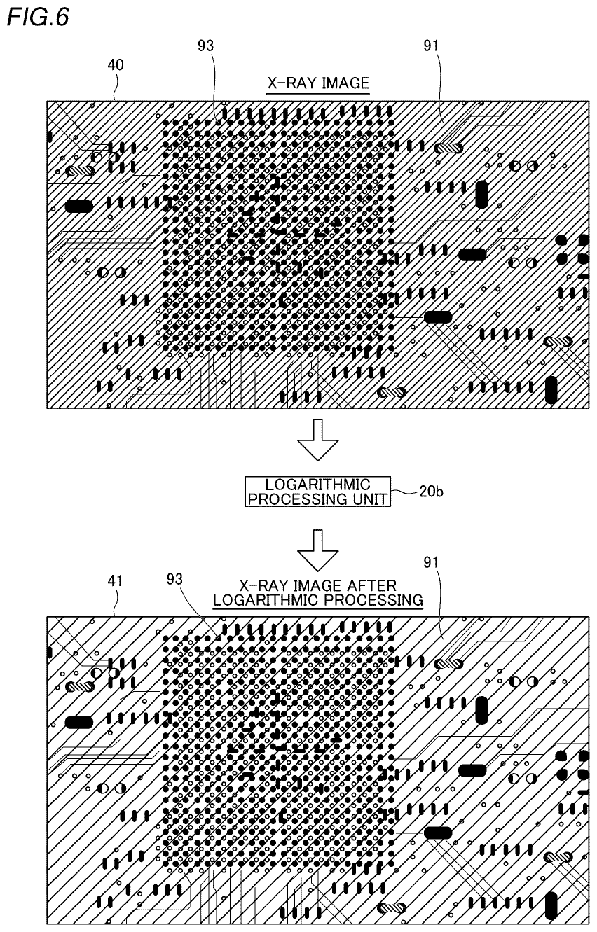

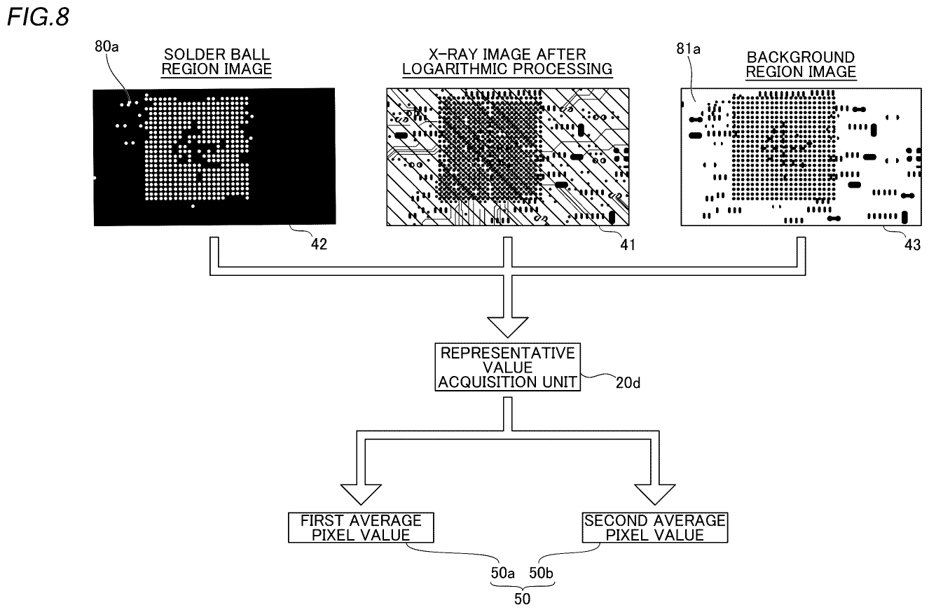

Next, a configuration in which the control unit 20 (see FIG. 3) acquires a contrast-adjusted X-ray image 44 (see FIG. 9) will be described with reference to FIG. 6 to FIG. 9. The configuration for the control unit 20 to acquire the contrast-adjusted X-ray image 44 broadly includes a configuration for performing logarithmic transformation processing on the X-ray image 40, a configuration for acquiring a plurality of regions from the X-ray image 40, a configuration for acquiring an X-ray image representative value 50 (see FIG. 8) from each of the plurality of regions, and a configuration for adjusting the contrast of the X-ray image 40 based on the X-ray image representative value 50.

First, a configuration in which the logarithmic processing unit 20b performs logarithmic processing on the X-ray image 40 to acquire a logarithmically transformed X-ray image 41 will be described with reference to FIG. 6.

In the present embodiment, the logarithmic processing unit 20b performs logarithmic transformation processing using the natural logarithm (logarithm to the base e) on each pixel of the X-ray image 40. This changes the variation of pixel values in the X-ray image from an exponential change to a linear change. Accordingly, the degree of change in pixel values in the low-dose portion increases, and as a result, the resolution of the low-dose portion is improved. In the example shown in FIG. 6, the hatching applied to the background of the X-ray image 40 before the logarithmic transformation processing and the hatching applied to the background of the logarithmically transformed X-ray image 41 are made different from each other to indicate that the resolution of the low-dose portion of the logarithmically transformed X-ray image 41 has been improved.

Next, a configuration in which the region acquisition unit 20c acquires a plurality of regions will be described with reference to FIG. 7.

As shown in FIG. 7, the region acquisition unit 20c is configured to acquire two regions: a first region 80, which is a region including the inspection object 90 (see FIG. 1), and a second region 81, which is a region other than the inspection object 90. In the present embodiment, the region acquisition unit 20c is configured to acquire the first region 80 and the second region 81 by performing binarization processing on the logarithmically transformed X-ray image 41. The region acquisition unit 20c acquires the first region 80 and the second region 81, for example, by Otsu's binarization method (discriminant analysis method), which can automatically determine the threshold for binarization.

In the present embodiment, the first region 80 is a solder ball region 80a where the plurality of solder balls 93 appear. The second region 81 is a background region 81a other than the solder ball region 80a. That is, in the present embodiment, the region acquisition unit 20c acquires the solder ball region 80a and the background region 81a from the logarithmically transformed X-ray image 41 by performing binarization processing. In the present embodiment, since the solder ball region 80a and the background region 81a are roughly divided by Otsu's binarization, the solder ball region 80a may include electronic components 94 (see FIG. 2) such as chip capacitors.

A first region image 42 shown in FIG. 7 is an image showing the solder ball region 80a. In the first region image 42, the solder ball region 80a is shown in white. In other words, the first region image 42 is a mask image of the solder ball region 80a.

A second region image 43 is an image showing the background region 81a. In the second region image 43, the background region 81a is shown in white. In other words, the second region image 43 is a mask image of the background region 81a.

Next, a configuration in which the representative value acquisition unit 20d acquires an X-ray image representative value 50 will be described with reference to FIG. 8.

The representative value acquisition unit 20d is configured to acquire an X-ray image representative value 50 of the solder ball region 80a and an X-ray image representative value 50 of the background region 81a. In the present embodiment, the representative value acquisition unit 20d is configured to acquire a first average pixel value 50a, which is the average pixel value of the first region 80, and a second average pixel value 50b, which is the average pixel value of the second region 81, as the X-ray image representative value 50.

Specifically, the representative value acquisition unit 20d acquires the solder ball region 80a from the X-ray image 41 based on the logarithmically transformed X-ray image 41 and the first region image 42. Then, the representative value acquisition unit 20d acquires the average value of the pixel values of each pixel included in the solder ball region 80a of the X-ray image 41 as the first average pixel value 50a.

The representative value acquisition unit 20d also acquires the background region 81a from the X-ray image 41 based on the logarithmically transformed X-ray image 41 and the second region image 43. Then, the representative value acquisition unit 20d acquires the average value of the pixel values of each pixel included in the background region 81a of the X-ray image 41 as the second average pixel value 50i.

Next, a configuration in which the contrast adjustment unit 20e adjusts the contrast of the X-ray image 40 (see FIG. 4) will be described with reference to FIG. 9.

The contrast adjustment unit 20e is configured to acquire a contrast-adjusted X-ray image 44 by performing contrast adjustment on the logarithmically transformed X-ray image 41 such that the X-ray image representative value 50 of each of the plurality of regions of the logarithmically transformed X-ray image 41 becomes a predetermined value 70 acquired based on the input training data 32 used when creating the trained model 31, based on the X-ray image representative value 50 (see FIG. 7) of the first region 80 (see FIG. 7) and the X-ray image representative value 50 (see FIG. 7) of the second region 81 (see FIG. 7). Specifically, the contrast adjustment unit 20e is configured to acquire the contrast-adjusted X-ray image 44 by performing contrast adjustment on the logarithmically transformed X-ray image 41 based on the first average pixel value 50a and the second average pixel value 50b, such that the X-ray image representative value 50 of each of the plurality of regions of the logarithmically transformed X-ray image 41 becomes the predetermined value 70.

The predetermined value 70 is acquired based on a training data representative value, which is a representative value of the pixels of each of the plurality of regions in the input training data 32 (see FIG. 5). The training data representative value is, for example, the average value (average pixel value) of the pixel values of each of the plurality of regions in the input training data 32. The predetermined value 70 is acquired when the trained model 31 is created and is stored in the storage unit 21.

In the present embodiment, the contrast adjustment unit 20e is configured to acquire the contrast-adjusted X-ray image 44 by adjusting the pixel values of the logarithmically transformed X-ray image 41 such that each of the first average pixel value 50a and the second average pixel value 50b becomes the predetermined value 70. The contrast adjustment unit 20e performs contrast adjustment on the logarithmically transformed X-ray image 41 such that the value of the first average pixel value 50a falls within the lower two-thirds range of the gray-scale range of the logarithmically transformed X-ray image 41, and the second average pixel value 50b falls within the upper one-third range of the gray-scale range of the logarithmically transformed X-ray image 41. Specifically, the contrast adjustment unit 20e performs contrast adjustment on the logarithmically transformed X-ray image 41 based on the following equation (1).

$$\begin{matrix}[ Equation 1 ] & \\ {J}_{i , j} = ( {I}_{i , j} - {μ}_{I}^{t} ) * \frac{( {c}^{b} - {c}^{t} )}{{μ}_{I}^{b} , - {μ}_{I}^{t}} + {μ}_{I}^{b} & ( 1 )\end{matrix}$$

Here, I_{i,j} is the pixel value (luminance value) of the pixel at the i-th row and j-th column of the input image I (logarithmically transformed X-ray image 41). J_{i,j} is the pixel value (luminance value) of the pixel at the i-th row and j-th column of the contrast-adjusted image J (contrast-adjusted X-ray image 44). μ^{t}_{I} and μ^{b}_{I} are the first average pixel value 50a and the second average pixel value 50b, respectively. c^{t} and c^{b} are the predetermined value 70 (average pixel value) for the first region 80 (solder ball region 80a) and the predetermined value 70 (average pixel value) for the second region 81 (background region 81a), respectively. The predetermined value 70 for the first region 80 (solder ball region 80a) is the representative value (average pixel value) of the pixel values of the solder ball region in the input training data 32. The predetermined value 70 for the second region 81 (background region 81a) is the representative value (average pixel value) of the pixel values of the background region in the input training data 32.

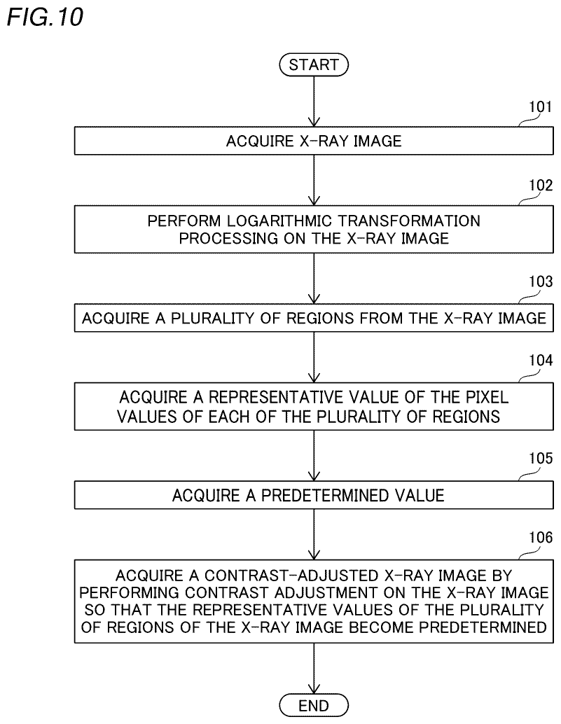

Next, the process of the X-ray image preprocessing method in which the control unit 20 (see FIG. 1) acquires the contrast-adjusted X-ray image 44 (see FIG. 9) will be described with reference to FIG. 10.

In step 101, the image generation unit 20a (see FIG. 3) acquires an X-ray image 40 (see FIG. 4). In the present embodiment, in step 101, the image generation unit 20a acquires the X-ray image 40 by generating the X-ray image 40 based on the X-rays detected by the X-ray detector 11 (see FIG. 1).

Next, in step 102, the logarithmic processing unit 20b performs logarithmic transformation processing on each pixel of the X-ray image 40, as shown in FIG. 6. In the present embodiment, the logarithmic processing unit 20b acquires a logarithmically transformed X-ray image 41 by performing logarithmic transformation processing on the X-ray image 40.

Next, in step 103, the region acquisition unit 20c acquires a plurality of regions from the X-ray image 40 based on the pixel values of the X-ray image 40, as shown in FIG. 7. In the present embodiment, the region acquisition unit 20c acquires two regions, a solder ball region 80a and a background region 81a, by performing binarization processing on the logarithmically transformed X-ray image 41.

Next, in step 104, the representative value acquisition unit 20d acquires an X-ray image representative value 50 of the pixel values of each of the plurality of regions, as shown in FIG. 8. In the present embodiment, the representative value acquisition unit 20d acquires a first average pixel value 50a from the solder ball region 80a and a second average pixel value 50b from the background region 81a as the X-ray image representative value 50.

Next, in step 105, the contrast adjustment unit 20e acquires a predetermined value 70 (see FIG. 1). Specifically, the contrast adjustment unit 20e acquires the predetermined value 70 stored in the storage unit.

Next, in step 106, the contrast adjustment unit 20e acquires a contrast-adjusted X-ray image 44 by performing contrast adjustment on the X-ray image 40 such that each X-ray image representative value 50 of the plurality of regions of the X-ray image 40 becomes a predetermined value 70 acquired based on the input training data 32 used when creating the trained model 31, as shown in FIG. 9. In the present embodiment, the contrast adjustment unit 20e acquires the contrast-adjusted X-ray image 44 based on the logarithmically transformed X-ray image 41, the first average pixel value 50a, and the second average pixel value 50b. Thereafter, the process ends.

### Effects of the Present Embodiment

In the present embodiment, the following effects can be obtained. In the present embodiment, as described above, the X-ray image preprocessing method is an X-ray image preprocessing method performed prior to a process of acquiring a region of the inspection object 90 from the X-ray image 40 of the inspection object 90 using the trained model 31, the method comprising: a step of acquiring the X-ray image 40; a step of acquiring a plurality of regions from the X-ray image 40 based on pixel values of the X-ray image 40; a step of acquiring an X-ray image representative value 50 of the pixel values of each of the plurality of regions; and a step of acquiring a contrast-adjusted X-ray image 44 by performing contrast adjustment on the X-ray image 40 such that each of the X-ray image representative values 50 of the plurality of regions of the X-ray image 40 becomes a predetermined value 70 acquired based on the input training data 32 used when creating the trained model 31.

When the X-ray imaging apparatus 1 undergoes aging degradation, even if a user sets the tube voltage and tube current to irradiate X-rays with a predetermined energy and dose, at least one of X-ray energy and dose actually irradiated from the X-ray irradiation unit may become lower. Therefore, when the X-ray imaging apparatus 1 undergoes aging degradation, the X-ray image 40 is captured under imaging conditions where at least one of the X-ray energy and dose is lower than the imaging conditions set by the user, resulting in a decrease in contrast between the plurality of regions in the X-ray image 40. Furthermore, if the X-ray irradiation unit 10 is replaced after capturing the input training data 32 used to generate the trained model 31, even if the user sets values equal to the tube voltage and tube current values that were set when capturing the input training data 32, at least one of X-ray energy and dose actually irradiated from the X-ray irradiation unit 10 may become higher than at least one of X-ray energy and dose irradiated from the X-ray irradiation unit 10 when the input training data 32 was captured. In this case, since the X-ray image 40 is captured under imaging conditions where at least one of the X-ray energy and dose is higher than the imaging conditions when the input training data 32 was captured, the contrast between the plurality of regions in the X-ray image 40 becomes greater than the contrast between the plurality of regions in the input training data 32.

Therefore, as described above, a contrast-adjusted X-ray image 44 is acquired by performing contrast adjustment on the X-ray image 40 such that each X-ray image representative value 50 of the plurality of regions of the X-ray image 40 becomes the predetermined value 70 acquired based on the input training data 32 used when creating the trained model 31. As a result, in both the case where at least one of X-ray energy and dose irradiated from the X-ray irradiation unit becomes lower and the contrast between the plurality of regions in the X-ray image 40 becomes lower than the contrast between the plurality of regions in the input training data 32, and the case where the contrast between the plurality of regions in the X-ray image 40 becomes greater than the contrast between the plurality of regions in the input training data 32, it is possible to acquire a contrast-adjusted X-ray image 44 in which the contrast is adjusted so that each X-ray image representative value 50 of the plurality of regions becomes the predetermined value 70 acquired based on the input training data 32 used when creating the trained model 31. Accordingly, the contrast between the plurality of regions in the X-ray image 40 can be brought closer to the contrast between the plurality of regions in the input training data 32. Consequently, even when the imaging conditions for capturing the training data for generating the trained model 31 and the imaging conditions for capturing the X-ray image 40 to be analyzed by the trained model 31 are different from each other, it is possible to suppress a decrease in the accuracy of the process for acquiring (identifying) the region of the inspection object 90 using the trained model 31. It should be noted that the ability to suppress a decrease in the accuracy of the process for acquiring the region of the inspection object 90 has been confirmed in an experiment described later by the present inventors.

Furthermore, in the present embodiment, as described above, the program 30 is an X-ray image preprocessing program performed prior to a process of acquiring a region of the inspection object 90 from the X-ray image 40 of the inspection object 90 using the trained model 31, the program causing a computer to execute: a control to acquire the X-ray image 40; a control to acquire a plurality of regions from the X-ray image 40 based on pixel values of the X-ray image 40; a control to acquire an X-ray image representative value 50 of the pixel values of each of the plurality of regions; and a control to acquire a contrast-adjusted X-ray image 44 by performing contrast adjustment on the X-ray image 40 such that each of the X-ray image representative values 50 of the plurality of regions of the X-ray image 40 becomes a predetermined value 70 acquired based on the input training data 32 used when creating the trained model 31.

This makes it possible to provide a program 30 that, similar to the X-ray image preprocessing method, can suppress a decrease in the accuracy of the process for acquiring (identifying) the region of the inspection object 90 using the trained model 31, even when the imaging conditions for capturing the training data for generating the trained model 31 and the imaging conditions for capturing the X-ray image 40 to be analyzed by the trained model 31 are different from each other.

Furthermore, in the present embodiment, the X-ray image preprocessing system 100 is an X-ray image preprocessing system performed prior to a process of acquiring a region of the inspection object 90 from the X-ray image 40 of the inspection object 90 using the trained model 31, the system comprising: an X-ray imaging apparatus 1 having an X-ray irradiation unit 10 that irradiates X-rays and an X-ray detector 11 that detects the X-rays irradiated from the X-ray irradiation unit 10; and an image processing apparatus 2 that generates an X-ray image 40, wherein the image processing apparatus 2 performs: a control to generate the X-ray image 40; and a control to acquire a plurality of regions from the X-ray image 40 based on pixel values of the X-ray image 40, acquire an X-ray image representative value 50 of the pixel values of each of the plurality of regions, and acquire a contrast-adjusted X-ray image 44 by performing contrast adjustment on the X-ray image 40 such that each of the X-ray image representative values 50 of the plurality of regions of the X-ray image 40 becomes the predetermined value 70.

This makes it possible to provide an X-ray image preprocessing system 100 that, similar to the X-ray image preprocessing method, can suppress a decrease in the accuracy of the process for acquiring (identifying) the region of the inspection object 90 using the trained model 31, even when the imaging conditions for capturing the training data for generating the trained model 31 and the imaging conditions for capturing the X-ray image 40 to be analyzed by the trained model 31 are different from each other.

Furthermore, in the present embodiment, the following further effects can be obtained by the configuration described below.

That is, in the present embodiment, as described above, the predetermined value 70 is acquired based on a training data representative value, which is a representative value of the pixels of each of the plurality of regions in the input training data 32 (training data). As a result, since the predetermined value 70 is the training data representative value, which is the representative value of the pixels of each of the plurality of regions of the input training data 32 (training data), by adjusting the contrast of the X-ray image such that each X-ray image representative value 50 of the plurality of regions of the X-ray image becomes the predetermined value 70, the magnitude of the contrast between the plurality of regions of the X-ray image 40 can be easily brought closer to the magnitude of the contrast between the plurality of regions in the input training data 32 (training data). Consequently, even when the imaging conditions for capturing the input training data 32 (training data) and the imaging conditions for capturing the X-ray image 40 to be analyzed by the trained model 31 are different from each other, a decrease in the accuracy of the process for acquiring (identifying) the region of the inspection object 90 using the trained model 31 can be easily suppressed.

In the step of acquiring a plurality of regions from the X-ray image 40, two regions are acquired: a first region 80 which is a region including the inspection object 90, and a second region 81 which is a region other than the inspection object 90. In the step of acquiring the contrast-adjusted X-ray image 44, the contrast-adjusted X-ray image 44 is acquired by performing contrast adjustment on the X-ray image 40 such that the X-ray image representative value 50 of the first region 80 and the X-ray image representative value 50 of the second region 81 become the predetermined value 70 for the first region 80 and the predetermined value 70 for the second region 81, respectively. As a result, in the contrast-adjusted X-ray image 44, compared to the X-ray image 40 on which contrast adjustment has not been performed, the contrast between the first region 80 and the second region 81 approaches the contrast between the first region and the second region of the input training data 32 (training data). Consequently, by using the contrast-adjusted X-ray image 44 for the process of acquiring the region of the inspection object 90 using the trained model 31, a decrease in the accuracy of the process for acquiring (identifying) the region of the inspection object 90 (analysis accuracy of the region of the inspection object 90) can be suppressed.

Furthermore, in the present embodiment, as described above, the method further comprises a step of performing logarithmic transformation processing on each pixel of the X-ray image 40 prior to the step of acquiring a plurality of regions from the X-ray image 40, and in the step of acquiring a plurality of regions from the X-ray image 40, the first region 80 and the second region 81 are acquired by performing binarization processing on the logarithmically transformed X-ray image 41. Here, the X-rays irradiated from the X-ray irradiation unit 10 and detected by the X-ray detector 11 after passing through the inspection object 90 attenuate exponentially according to the distance between the X-ray irradiation unit 10 and the X-ray detector 11. Therefore, the resolution of the low-dose portion in the X-ray image 40 becomes lower than the resolution of the high-dose portion in the X-ray image 40. By performing logarithmic transformation processing as described above, the change in pixel values in the X-ray image 40 becomes linear, so that blur in the low-dose portion of the X-ray image 40 is eliminated, and the resolution of the low-dose portion in the X-ray image 40 can be improved. Furthermore, by performing logarithmic transformation on the X-ray image 40, the change in pixel values can be converted to a linear change in the logarithmically transformed X-ray image 41. As a result of these, since the first region 80 and the second region 81 can be acquired by performing binarization processing on the logarithmically transformed X-ray image 41 in which the resolution of the low-dose portion is improved and the change in pixel values is converted to a linear change, the first region 80 and the second region 81 can be acquired with higher accuracy compared to a configuration in which the first region 80 and the second region 81 are acquired by performing binarization processing on the X-ray image 40 on which logarithmic transformation processing has not been performed.

Furthermore, in the present embodiment, as described above, the X-ray image 40 is an image showing a circuit board 91 on which a plurality of solder balls 93 are arranged, the first region 80 is a solder ball region 80a where the plurality of solder balls 93 appear, the second region 81 is a background region 81a other than the solder ball region 80a, and in the step of acquiring a plurality of regions from the X-ray image 40, the solder ball region 80a and the background region 81a are acquired from the logarithmically transformed X-ray image 41 by performing binarization processing, and in the step of acquiring the X-ray image representative value 50, the X-ray image representative value 50 of the solder ball region 80a and the X-ray image representative value 50 of the background region 81a are acquired. As a result, the contrast between the solder ball region 80a and the background region 81a can be brought closer to the contrast between the solder ball region and the background region in the input training data 32 (training data). Consequently, a decrease in the accuracy of the process for acquiring (identifying) the solder ball region 80a in the contrast-adjusted X-ray image 44 using the trained model 31 can be suppressed. It should be noted that the ability to suppress a decrease in the accuracy of the process for acquiring (identifying) the solder ball region 80a using the trained model 31 has been confirmed in an experiment described later by the present inventors.

Furthermore, in the present embodiment, as described above, in the step of acquiring the X-ray image representative value 50, a first average pixel value 50a, which is the average pixel value of the first region 80, and a second average pixel value 50b, which is the average pixel value of the second region 81, are acquired as the X-ray image representative value 50, and in the step of acquiring the contrast-adjusted X-ray image 44, the contrast-adjusted X-ray image 44 is acquired by performing contrast adjustment on the X-ray image 40 such that each of the first average pixel value 50a and the second average pixel value 50b becomes the predetermined value 70. As a result, when adjusting the contrast between the first region 80 and the second region 81, since the contrast adjustment of the X-ray image 40 is performed using the first average pixel value 50a and the second average pixel value 50b as the X-ray image representative value 50, it is possible to suppress excessively lowering the pixel values in the first region 80 or excessively raising the pixel values in the second region 81. It is also possible to suppress excessively raising the pixel values in the first region 80 or excessively lowering the pixel values in the second region 81. Consequently, the contrast of the X-ray image 40 can be adjusted easily and with high accuracy.

### First Example (Effect Confirmation Experiment)

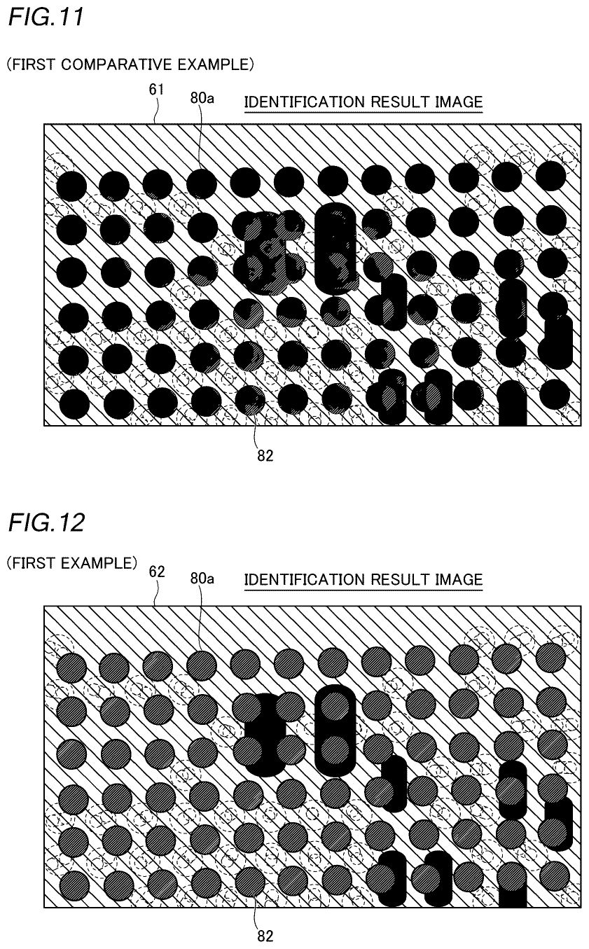

To confirm the effects of the above-described embodiment, the following experiment was conducted. That is, the identification accuracy of the solder ball region 80a (see FIG. 11) was compared between an identification result image 61 according to a first comparative example (see FIG. 11) and an identification result image 62 according to a first example (see FIG. 12).

The identification result image 61 according to the first comparative example shown in FIG. 11 is an identification result output using the trained model 31 and an X-ray image captured with a different tube voltage from the imaging conditions at the time of capturing the training data for generating the trained model 31 (see FIG. 1). Specifically, a trained model 31 generated using training data captured under imaging conditions of a tube voltage of 120 kV (kilovolts) and a tube current of 100 μA (microamperes) was used. The X-ray image was captured under imaging conditions of a tube voltage of 100 kV and a tube current of 100 μA. In the first comparative example, by intentionally setting the tube voltage value low, a state was reproduced in which the X-ray irradiation unit 10 undergoes aging degradation and the energy of the irradiated X-rays becomes low.

In the identification result image 61, the identification result by the trained model 31 is superimposed as a label 82. In the identification result image 61, the label 82 is not superimposed on many of the solder ball regions 80a. That is, it was confirmed that when the tube voltage value at the time of capturing the training data and the tube voltage value at the time of capturing the X-ray image were different from each other, the analysis accuracy by the trained model 31 decreased.

In the first example shown in FIG. 12 as well, an X-ray image captured under imaging conditions of a tube voltage of 100 kV and a tube current of 100 μA was subjected to contrast adjustment by the X-ray image preprocessing method shown in the above embodiment, and the resulting contrast-adjusted X-ray image 44 was input to the trained model 31 to obtain an identification result image 62. In the first example as well, by intentionally setting the tube voltage value low, a state was reproduced in which the X-ray irradiation unit 10 undergoes aging degradation and the energy of the irradiated X-rays becomes low.

In the identification result image 62 as well, the identification result by the trained model 31 is superimposed as a label 82. In the identification result image 62, the label 82 is superimposed so as to match the solder ball regions 80a. That is, it was confirmed that even when the tube voltage value at the time of capturing the training data and the tube voltage value at the time of capturing the X-ray image were different from each other, it is possible to suppress a decrease in the analysis accuracy by the trained model 31.

### Second Example (Effect Confirmation Experiment)

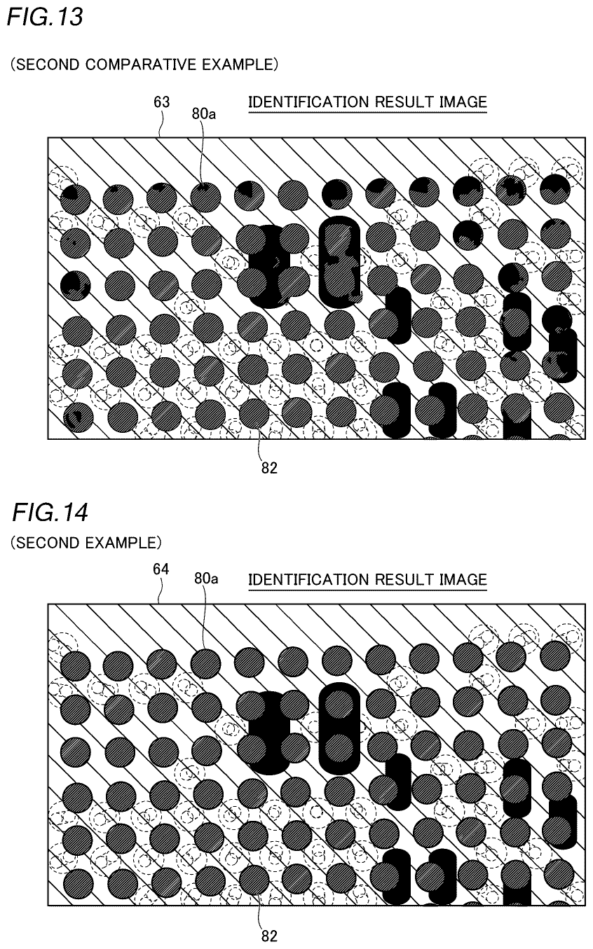

Furthermore, to confirm the effects of the above-described embodiment, the following experiment was conducted. That is, the identification accuracy of the solder ball region 80a (see FIG. 13) was compared between an identification result image 63 according to a second comparative example (see FIG. 13) and an identification result image 64 according to a second example (see FIG. 14).

The identification result image 63 according to the second comparative example shown in FIG. 13 is an identification result output using the trained model 31 and an X-ray image captured with a different tube current from the imaging conditions at the time of capturing the training data for generating the trained model 31. Specifically, a trained model 31 generated using training data captured under imaging conditions of a tube voltage of 120 kV (kilovolts) and a tube current of 100 μA (microamperes) was used. The X-ray image was captured under imaging conditions of a tube voltage of 120 kV and a tube current of 50 μA. In the second comparative example, by intentionally setting the tube current value low, a state was reproduced in which the X-ray irradiation unit 10 undergoes aging degradation and the dose of the irradiated X-rays becomes low.

In the identification result image 63, the identification result by the trained model 31 is superimposed as a label 82. In the identification result image 63, although the label 82 is superimposed on many of the solder ball regions 80a, the label 82 is not superimposed on some of the solder ball regions 80a. That is, it was confirmed that when the tube current value at the time of capturing the training data and the tube current value at the time of capturing the X-ray image were different from each other, the analysis accuracy by the trained model 31 decreased.

In the second example shown in FIG. 14 as well, an X-ray image captured under imaging conditions of a tube voltage of 120 kV and a tube current of 50 μA was subjected to contrast adjustment by the X-ray image preprocessing method shown in the above embodiment, and the resulting contrast-adjusted X-ray image 44 was input to the trained model 31 to obtain an identification result image 64. In the second example as well, by intentionally setting the tube current value low, a state was reproduced in which the X-ray irradiation unit 10 undergoes aging degradation and the dose of the irradiated X-rays becomes low.

In the identification result image 64 as well, the identification result by the trained model 31 is superimposed as a label 82. In the identification result image 64, the label 82 is superimposed so as to match the solder ball regions 80a. That is, it was confirmed that even when the tube current value at the time of capturing the training data and the tube current value at the time of capturing the X-ray image were different from each other, it is possible to suppress a decrease in the analysis accuracy by the trained model 31.

From the above experimental results, it was confirmed that when analyzing the contrast-adjusted X-ray image 44 obtained by the X-ray image preprocessing method according to the above embodiment using the trained model 31, it is possible to suppress a decrease in the analysis accuracy by the trained model 31 even if both X-ray energy and dose irradiated from the X-ray irradiation unit are different from X-ray energy and dose at the time of capturing the training data. That is, it was confirmed that it is possible to suppress a decrease in the accuracy of the process for acquiring (identifying) the first region 80 (solder ball region 80a) using the trained model 31.

### Modifications

It should be understood that the embodiments and examples disclosed herein are illustrative and not restrictive in all respects. The scope of the present invention is indicated by the claims rather than by the description of the embodiments and examples above, and all modifications (variations) within the meaning and scope equivalent to the claims are intended to be included.

For example, in the above embodiment, an example of a configuration was shown in which the control unit 20 (region acquisition unit 20c) acquires two regions, the first region 80 and the second region 81, from the X-ray image 40 as a plurality of regions, but the present invention is not limited thereto. For example, the control unit (region acquisition unit) may be configured to acquire three or more regions from the X-ray image as a plurality of regions. The number of regions acquired by the control unit (region acquisition unit) may be changed depending on the number of targets to be analyzed by the trained model.

In the above embodiment, an example of a configuration was shown in which the control unit 20 (logarithmic processing unit 20b) performs logarithmic transformation processing on the X-ray image 40 prior to the process of acquiring a plurality of regions from the X-ray image 40, but the present invention is not limited thereto. For example, the control unit (logarithmic transformation processing unit) may not perform logarithmic transformation processing on the X-ray image. However, if the control unit (logarithmic processing unit) does not perform logarithmic transformation processing on the X-ray image, binarization processing will be performed with the resolution of the low-dose portion of the X-ray image being low and the change in pixel values remaining exponential. In this case, the accuracy of acquiring the first region and the second region by binarization processing decreases. Therefore, it is preferable that the control unit (logarithmic processing unit) is configured to perform logarithmic transformation processing on the X-ray image.

In the above embodiment, an example of a configuration was shown in which the control unit 20 (region acquisition unit 20c) acquires the first region 80 and the second region 81 by performing binarization processing on the logarithmically transformed X-ray image 41, but the present invention is not limited thereto. As long as the first region and the second region can be acquired from the X-ray image, the control unit (region acquisition unit) may acquire the first region and the second region by a method other than binarization processing. For example, the control unit (region acquisition unit) may be configured to acquire the first region and the second region from the X-ray image by a Split-Merge method, which divides an image into sub-regions with uniform features.

In the above embodiment, an example of a configuration was shown in which the control unit 20 (region acquisition unit 20c) acquires the first region 80 and the second region 81 by Otsu's binarization method, but the present invention is not limited thereto. For example, the control unit (region acquisition unit) may be configured to acquire the first region and the second region from the X-ray image by a binarization method other than Otsu's binarization method. For example, the control unit (region acquisition unit) may be configured to acquire the first region and the second region by binarization processing based on a threshold value set (input) by a user.

In the above embodiment, an example was shown in which the X-ray image 40 is an image showing the circuit board 91 on which the solder balls 93 are arranged, but the present invention is not limited thereto. For example, the X-ray image may be an image showing an inspection object other than solder balls. In this case, the control unit (region acquisition unit) may be configured to acquire a region where the inspection object appears and a region other than the inspection object from the X-ray image.

In the above embodiment, an example of a configuration was shown in which the control unit 20 (representative value acquisition unit 20d) acquires the first average pixel value 50a and the second average pixel value 50b as the X-ray image representative value 50, but the present invention is not limited thereto. For example, the control unit (representative value acquisition unit) may be configured to acquire the median value, mode value, or the like of each pixel value in the first region and the second region as the X-ray image representative value.

In the above embodiment, an example of a configuration was shown in which the control unit 20 (contrast adjustment unit 20e) adjusts the pixel values of the X-ray image 40 (logarithmically transformed X-ray image 41) such that each of the first average pixel value 50a and the second average pixel value 50b becomes the predetermined value 70, but the present invention is not limited thereto. For example, the control unit (contrast adjustment unit) may be configured to adjust the pixel values of the X-ray image (logarithmically transformed X-ray image) such that either the median value or the mode value of the pixel values of each of the first region and the second region becomes the predetermined value 70.

In the above embodiment, an example of a configuration was shown in which the control unit 20 (region acquisition unit 20c) acquires the solder ball region 80a, which is the region of the solder balls 93 of a BGA (Ball Grid Array), but the present invention is not limited thereto. For example, the control unit (region acquisition unit) may be configured to acquire a region of a plurality of solder materials at the connection portions of a plurality of terminals of an LGA (Land Grid Array) in which terminals are arranged in a grid pattern. Alternatively, the control unit (region acquisition unit) may acquire a region of the plurality of terminals instead of the solder material.

In the above embodiment, an example was shown in which the predetermined value 70 is the average pixel value of the first region and the average pixel value of the second region of the input training data 32 (training data), but the present invention is not limited thereto. For example, the predetermined value may be either the median value or the mode value of the pixel values of the first region, and either the median value or the mode value of the pixel values of the second region of the input training data (training data).

In the above embodiment, an example was shown in which the X-ray imaging apparatus 1 and the image processing apparatus 2 are provided separately, but the present invention is not limited thereto. In the present invention, the X-ray imaging apparatus and the image processing apparatus may be integrally configured.

In the above embodiment, an example of a configuration was shown in which the image processing apparatus 2 stores the trained model 31, but the present invention is not limited thereto. When the preprocessing for the X-ray image and the analysis of the preprocessed X-ray image (contrast-adjusted X-ray image) are performed by separately provided control devices, the image processing apparatus does not need to store the trained model.

In the above embodiment, an example of a configuration was shown in which the plurality of solder balls 93 are arranged on one surface of the circuit board 91, but the present invention is not limited thereto. The present invention can also be applied to a configuration in which a plurality of solder balls 93 are arranged on both the front and back surfaces of the circuit board 91.

In the above embodiment, the process in which the control unit 20 acquires the contrast-adjusted X-ray image 44 was described using a flow-driven flowchart in which processes are performed sequentially along a processing flow, but the present invention is not limited thereto. In the present invention, the processing performed by the control unit may be performed by event-driven processing in which processing is executed on an event-by-event basis. In this case, it may be performed in a completely event-driven manner, or by a combination of event-driven and flow-driven processing.

### Aspects

It will be understood by those skilled in the art that the exemplary embodiments described above are specific examples of the following aspects.

### (Item 1)

An X-ray image preprocessing method performed prior to a process of acquiring a region of an inspection object from an X-ray image of the inspection object using a trained model, the method comprising:
a step of acquiring the X-ray image;
a step of acquiring a plurality of regions from the X-ray image based on pixel values of the X-ray image;
a step of acquiring an X-ray image representative value of the pixel values of each of the plurality of regions; and
a step of acquiring a contrast-adjusted X-ray image by performing contrast adjustment on the X-ray image such that each of the X-ray image representative values of the plurality of regions of the X-ray image becomes a predetermined value acquired based on training data used when creating the trained model.

### (Item 2)

The X-ray image preprocessing method according to item 1, wherein the predetermined value is acquired based on a training data representative value, which is a representative value of the pixels of each of the plurality of regions in the training data.

### (Item 3)

The X-ray image preprocessing method according to item 1 or 2, wherein, in the step of acquiring the plurality of regions from the X-ray image, two regions are acquired: a first region which is a region including the inspection object, and a second region which is a region other than the inspection object, and
in the step of acquiring the contrast-adjusted X-ray image, the contrast-adjusted X-ray image is acquired by performing contrast adjustment on the X-ray image such that the X-ray image representative value of the first region and the X-ray image representative value of the second region become the predetermined value for the first region and the predetermined value for the second region, respectively.

### (Item 4)

The X-ray image preprocessing method according to item 3, further comprising a step of performing logarithmic transformation processing on each pixel of the X-ray image prior to the step of acquiring the plurality of regions from the X-ray image, wherein, in the step of acquiring the plurality of regions from the X-ray image, the first region and the second region are acquired by performing binarization processing on the logarithmically transformed X-ray image.

### (Item 5)

The X-ray image preprocessing method according to item 4, wherein the X-ray image is an image showing a circuit board on which a plurality of solder balls are arranged,
the first region is a solder ball region where the plurality of solder balls appear,
the second region is a background region other than the solder ball region,
in the step of acquiring the plurality of regions from the X-ray image, the solder ball region and the background region are acquired from the logarithmically transformed X-ray image by performing binarization processing, and
in the step of acquiring the X-ray image representative value, the X-ray image representative value of the solder ball region and the X-ray image representative value of the background region are acquired.

### (Item 6)

The X-ray image preprocessing method according to any one of items 3 to 5, wherein, in the step of acquiring the X-ray image representative value, a first average pixel value, which is the average pixel value of the first region, and a second average pixel value, which is the average pixel value of the second region, are acquired as the X-ray image representative value, and
in the step of acquiring the contrast-adjusted X-ray image, the contrast-adjusted X-ray image is acquired by performing contrast adjustment on the X-ray image such that each of the first average pixel value and the second average pixel value becomes the predetermined value.

### (Item 7)

An X-ray image preprocessing program performed prior to a process of acquiring a region of an inspection object from an X-ray image of the inspection object using a trained model, the program causing a computer to execute:
a control to acquire the X-ray image;
a control to acquire a plurality of regions from the X-ray image based on pixel values of the X-ray image;
a control to acquire an X-ray image representative value of the pixel values of each of the plurality of regions; and
a control to acquire a contrast-adjusted X-ray image by performing contrast adjustment on the X-ray image such that each of the X-ray image representative values of the plurality of regions of the X-ray image becomes a predetermined value acquired based on training data used when creating the trained model.

### (Item 8)

An X-ray image preprocessing system performed prior to a process of acquiring a region of an inspection object from an X-ray image of the inspection object using a trained model, the system comprising:
an X-ray imaging apparatus having an X-ray irradiation unit that irradiates X-rays and an X-ray detector that detects the X-rays irradiated from the X-ray irradiation unit; and
an image processing apparatus that generates the X-ray image,
wherein the image processing apparatus performs:
a control to generate the X-ray image; and
a control to acquire a plurality of regions from the X-ray image based on pixel values of the X-ray image, acquire an X-ray image representative value of the pixel values of each of the plurality of regions, and acquire a contrast-adjusted X-ray image by performing contrast adjustment on the X-ray image such that each of the X-ray image representative values of the plurality of regions of the acquired X-ray image becomes a predetermined value acquired based on training data used when creating the trained model.

### REFERENCE SIGNS LIST

1 X-ray imaging apparatus
2 Image processing apparatus
10 X-ray irradiation unit
11 X-ray detector
20 Control unit
30 Program (X-ray image preprocessing program)
31 Trained model
32 Input training data (Training data)
40 X-ray image
41 Logarithmically transformed X-ray image
44 Contrast-adjusted X-ray image
70 Predetermined value
80 First region
80a Solder ball region
81 Second region
81a Background region
90 Inspection object
91 circuit board
93 Solder ball
100 X-ray image preprocessing system

1. An X-ray image preprocessing method performed prior to a process of acquiring a region of an inspection object from an X-ray image of the inspection object using a trained model, the method comprising:
acquiring the X-ray image;
acquiring a plurality of regions from the X-ray image based on pixel values of the X-ray image;
acquiring an X-ray image representative value, which is a representative value of pixel values of each of the plurality of regions; and
acquiring a contrast-adjusted X-ray image by performing contrast adjustment on the X-ray image such that each of the X-ray image representative values of the plurality of regions of the X-ray image becomes a predetermined value acquired based on training data used when creating the trained model.

2. The X-ray image preprocessing method according to claim 1, wherein the predetermined value is acquired based on a training data representative value, which is a representative value of the pixels of each of the plurality of regions in the training data.

3. The X-ray image preprocessing method according to claim 2, wherein, in acquiring the plurality of regions from the X-ray image, two regions are acquired: a first region which is a region including the inspection object, and a second region which is a region other than the inspection object, and
in acquiring the contrast-adjusted X-ray image, the contrast-adjusted X-ray image is acquired by performing contrast adjustment on the X-ray image such that the X-ray image representative value of the first region and the X-ray image representative value of the second region become the predetermined value for the first region and the predetermined value for the second region, respectively.

4. The X-ray image preprocessing method according to claim 3, further comprising performing logarithmic transformation processing on each pixel of the X-ray image prior to acquiring the plurality of regions from the X-ray image,
wherein, in acquiring the plurality of regions from the X-ray image, the first region and the second region are acquired by performing binarization processing on the logarithmically transformed X-ray image.

5. The X-ray image preprocessing method according to claim 4, wherein the X-ray image is an image showing a circuit board on which a plurality of solder balls are arranged,
the first region is a solder ball region where the plurality of solder balls appear,
the second region is a background region other than the solder ball region,
in acquiring the plurality of regions from the X-ray image, the solder ball region and the background region are acquired from the logarithmically transformed X-ray image by performing binarization processing, and
in acquiring the X-ray image representative value, the X-ray image representative value of the solder ball region and the X-ray image representative value of the background region are acquired.

6. The X-ray image preprocessing method according to claim 3, wherein, in acquiring the X-ray image representative value, a first average pixel value, which is an average pixel value of the first region, and a second average pixel value, which is an average pixel value of the second region, are acquired as the X-ray image representative value, and
in acquiring the contrast-adjusted X-ray image, the contrast-adjusted X-ray image is acquired by performing contrast adjustment on the X-ray image such that each of the first average pixel value and the second average pixel value becomes the predetermined value.

7. An X-ray image preprocessing program performed prior to a process of acquiring a region of an inspection object from an X-ray image of the inspection object using a trained model, the program causing a computer to execute:
a control to acquire the X-ray image;
a control to acquire a plurality of regions from the X-ray image based on pixel values of the X-ray image;
a control to acquire an X-ray image representative value of the pixel values of each of the plurality of regions; and
a control to acquire a contrast-adjusted X-ray image by performing contrast adjustment on the X-ray image such that each of the X-ray image representative values of the plurality of regions of the X-ray image becomes a predetermined value acquired based on training data used when creating the trained model.

8. An X-ray image preprocessing system performed prior to a process of acquiring a region of an inspection object from an X-ray image of the inspection object using a trained model, the system comprising:
an X-ray imaging apparatus having an X-ray irradiation unit that irradiates X-rays and an X-ray detector that detects the X-rays irradiated from the X-ray irradiation unit; and
an image processing apparatus that generates the X-ray image,
wherein the image processing apparatus performs:
a control to generate the X-ray image; and
a control to acquire a plurality of regions from the X-ray image based on pixel values of the X-ray image, acquire an X-ray image representative value of the pixel values of each of the plurality of regions, and acquire a contrast-adjusted X-ray image by performing contrast adjustment on the X-ray image such that each of the X-ray image representative values of the plurality of regions of the X-ray image becomes a predetermined value acquired based on training data used when creating the trained model.
